(19) United States
(12) Patent Application Publication
(10) Pub. No.: US 2006/0288314 A1
(43) Pub. Date: Dec. 21, 2006

(54) Facilitating cursor interaction with display objects

(75) Inventor: George G. Robertson, Seattle, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation, Redmond, WA (US)

(21) Appl. No.: 11/154,987

(22) Filed: Jun. 15, 2005

(51) Int. Cl. G06F 9/00; G06F 17/00

(52) U.S. Cl. 715/863; 715/858; 715/860; 715/859

(57) ABSTRACT

A system and method for facilitating location of cursor position and cursor movement in a computer display. A computer system obtains a user manipulation of a cursor and calculates a movement vector. The computer system then displays visual cues related to the movement vector. The visual cues can correspond to an automatic selection of display objects intersecting the direction of user manipulation or the automatic movement of the cursor in the detected direction The visual cues can also correspond to selecting target display objects prior to moving the cursor or the association of various acceleration thresholds as the cursor is moved.

### BACKGROUND

Computing devices, such as personal computers, can include a screen display and various input devices that facilitate computer/human interaction via a graphical user interface (“GUI”). Typically, GUIs include a graphical selection tool, such as a cursor icon, and number of display objects that can be manipulated by a user. In the most typical scenario, a user can manipulate the cursor through interaction with an input device and cause various sets of actions on one or more display objects. For example, a user can instantiate a software application by selecting a graphical icon display object associated with the application. In another example, a user can manage the display space by selecting display objects (such as icons) and moving them within the available display space.

The portion of the screen display utilized to display the display objects and operating system-provided controls is generally referred to as the desktop portion of the GUI. The ability for a user to efficiently identify the current location of the cursor display object within the desktop and/or manipulate the cursor to interact with a target display object within the desktop is important for providing a better and more efficient user experience with the GUI. In a typical embodiment, the cursor remains in its most current location and will often be hidden after a period of inactivity. To manipulate display objects, the user typically has to reacquire the location of the cursor and then attempt to carry out the desired action. Oftentimes, users are required to make exaggerated movements with input devices, such as a mouse, to locate the cursor on the display screen.

The continued development of larger display screens and/or the combination of multiple display screens to form the desktop of the GUI increases the possibility that a user may not readily identify the current position of the cursor. Additionally, a larger desktop area can create additional deficiencies in requiring the user to manipulate the cursor over larger pieces of the desktop to interact with a particular display objects. For example, in a desktop corresponding to 9 display screens arranged in a 3 by 3 matrix, a user may have some difficulty identifying the current location of the cursor and/or efficiently manipulating the cursor over multiple screens to interact with a particular icon. In these scenarios, a user may have difficulty directing the movement of the cursors, such as with a mouse, to intercept/select a selected display object.

Some attempts to facilitate cursor recognition correspond to the generation displaying of visual aids on the display screen. Examples of such visual aids include enlarging the cursor icon, changing the display property of the cursor such as color or shape, and highlighting the cursor with additional graphics or other visual aids. These approaches, however, do not provide much assistance in terms of facilitating cursor movement to interact with specific display objects. Other attempts to facilitate cursor movement tracking include generating a series of cursor images that match a path of previous cursor movement. These approaches can assist in visually identifying cursor movement, but still do not facilitate cursor interaction with display objects in the desktop, especially in larger, multi-screen desktops.

### SUMMARY

In accordance with one aspect of the invention, a method for facilitating a location of a cursor in a screen display is provided. A computer system obtains a user manipulation of a cursor displayed on the screen display and determines a direction for the user manipulation of the cursor. Based upon the direction of the user manipulation of the cursor, the computer system generates visual cues relating to the detected user manipulation. The visual cues can correspond to an automatic selection of display objects intersecting the direction of user manipulation or the automatic movement of the cursor in the detected direction The visual cues can also correspond to selecting target display objects prior to moving the cursor or the association of various acceleration thresholds as the cursor is moved.

In accordance with another aspect of the present invention, a method for facilitating the location of a cursor in a desktop area corresponding to two or more display screens having a plurality of display objects displayed on the desktop area is provided. In accordance with the method, a computer system obtains a user manipulation of a cursor displayed on the screen display. The manipulation can correspond to a variety of user input devices. The computer system then calculates a movement vector corresponding to the user manipulation of the cursor. The computer system then modifies the display of the cursor based upon the movement vector.

### BRIEF DESCRIPTION OF THE DRAWINGS

The foregoing aspects and many of the attendant advantages will become more readily appreciated as the same become better understood by reference to the following detailed description, when taken in conjunction with the accompanying drawings, wherein:

FIG. 1 is a flow diagram illustrative of a cursor identification and movement processing routine implemented by a computer system in accordance with an aspect of the present invention;

FIG. 2 is flow diagram illustrative of a sub-routine for automatically moving a cursor to a target display object in accordance with an aspect of the present invention;

FIGS. 3A-3C are block diagrams of a screen display having a cursor and multiple display objects and illustrating the automatic movement of a cursor to a target display object in accordance with an aspect of the present invention;

FIG. 4 is a flow diagram illustrative of a sub-routine for automatically moving a cursor along a calculated movement vector in accordance with an aspect of the present invention;

FIGS. 5A-5C are block diagrams of a screen display having a cursor and multiple display objects and illustrating the automatic traversal of a cursor along a movement vector in accordance with an aspect of the present invention;

FIG. 6 is a flow diagram illustrative of a sub-routine for moving a cursor along a calculated movement vector and incorporating a user-specified directional input in accordance with an aspect of the present invention;

FIG. 7A-7B are block diagrams of a screen display having a cursor and multiple display objects and illustrating the automatic traversal of a cursor along a movement vector in accordance with an aspect of the present invention;

FIG. 8 is a flow diagram illustrative of a sub-routine for automatically selecting display objects along a movement vector of a cursor in accordance with an aspect of the present invention;

FIGS. 9A-9C are block diagrams of a screen display having a cursor and multiple display objects and illustrating the selection of various display objects along a movement vector in accordance with an aspect of the present invention;

FIG. 10 is a flow diagram illustrative of a sub-routine for associating various acceleration vectors for cursor movement based upon the current location of the cursor and the current location of a target display object in accordance with an aspect of the present invention;

FIG. 11 is a block diagram of a screen display having a cursor and multiple display objects and illustrating the association of acceleration vectors for a cursor in accordance with an aspect of the present invention;

### DETAILED DESCRIPTION

Generally described, a method and computer-readable medium are provided for facilitating recognition of cursor position and movement in a screen display. More specifically, the present invention is directed to various methods for utilizing a determined cursor movement vector to locate a current cursor position and/or identify potential target display objects. Although the present invention will be described with regard to illustrative screen displays, graphical user interfaces and multiple screen desktops, one skilled in the relevant art will appreciate that the disclosed embodiments are illustrative in nature and should not be construed as limiting.

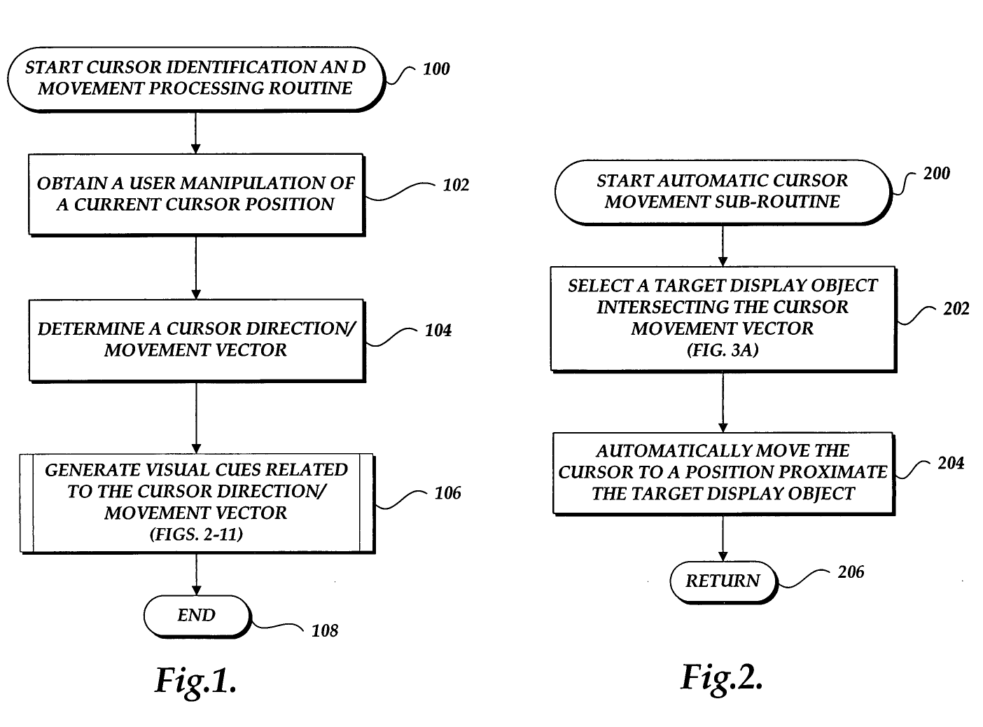

With reference to FIG. 1, a routine 100 for identifying a current cursor location and/or facilitating the movement of the cursor along the desktop of a graphical user interface will be described. The routine 100, and its various sub-routines described below, may be implemented on a wide variety of computing devices having one or more screen displays, a graphical user interface defining a graphical desktop, and one or more user input devices. The computing devices can include, but are not limited, to personal computers, mobile computing devices, gaming equipment, mobile telephones, hand-held computing devices, terminals, and the like. Additionally, the one or more user input device can include, but are not limited, to computer mice, trackballs, keypad, keyboard, screen input devices (e.g., such as digitizer pens and stylus), and the like.

Referring to FIG. 1, at block 102, the computing device obtains a user manipulation of a current cursor position. In accordance with an illustrative embodiment, the user manipulation of a current cursor position can correspond to a manipulation of the current cursor position by a user via one or more input devices. In a typical embodiment, a user will manipulate the cursor position by controlling a mouse. The detection of the user manipulation may be part of component for detecting cursor movement and/or can be one or more operating system functions relating to displaying and manipulating cursors with input devices. At block 104, the computing device determines a cursor direction, or cursor movement vector, corresponding to the detected movement. In an illustrative embodiment, the cursor direction/movement vector is calculated relative to the orientation of the screen displays that make up the available desktop area. In an alternative embodiment, a direction/movement vector speed may also be collected or calculated. At block 106, the computer system generates one or more visual cues related to the cursor direction/movement vector. Several embodiments for generating visuals cues will be described below with regard to FIGS. 2-11. In an illustrative embodiment, a user may configure a computer system to utilize one or more of the interaction embodiments. Additionally, the computer system can include some criteria to select which one of the embodiments will be best suited for particular computer hardware (e.g., the number of screens) and/or use by a user. At block 108, the routine 100 terminates.

With reference now to FIG. 2, a sub-routine 200 for automatically moving a cursor to a target display object and corresponding to block 106 (FIG. 1) will be described. At block 202, the computing system selects a target display object based on the calculated direction/movement vector of the cursor. In an illustrative embodiment of the present invention, the current movement vector can be projected along the desktop area of the display screen. Any display objects intersected by the project movement vector may be considered potential target display objects. Additionally, additional display objects within a threshold distance, such as measured in a pixels, may be also be considered potential target display objects. If multiple display objects may be potential target display objects, the computer system may utilize selection criteria to select a specific display object. For example, the computer system may select display objects that intersect the movement vector over display objects that are within the threshold distance. Similarly, the computer system may select display objects that are closer to the current position of the cursor over display objects that are further away. If no display objects intersect with the projected movement vector or are outside of a provide range, no display objects may be selected. Alternatively, the computer system may select a display object most close to the movement vector.

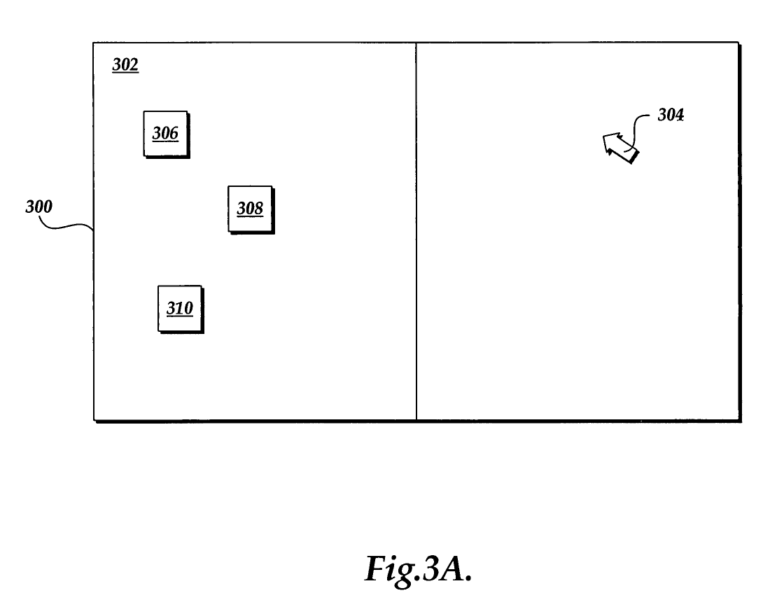

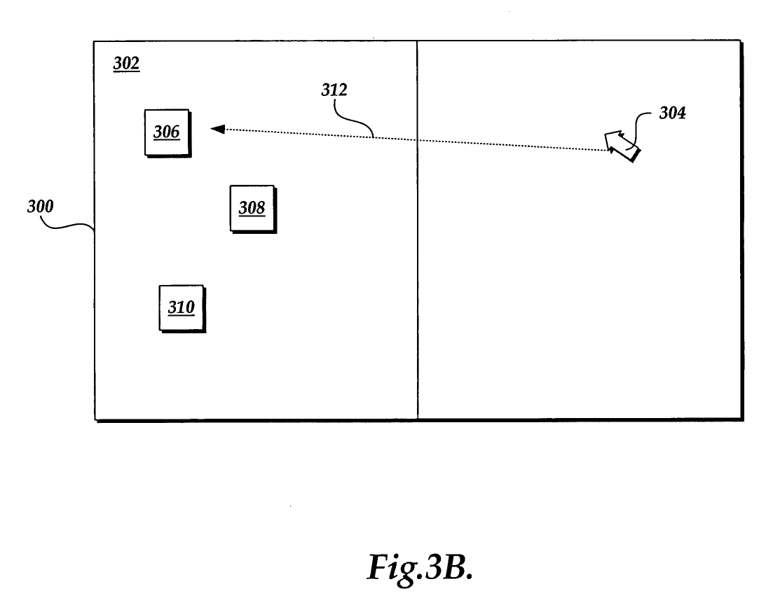

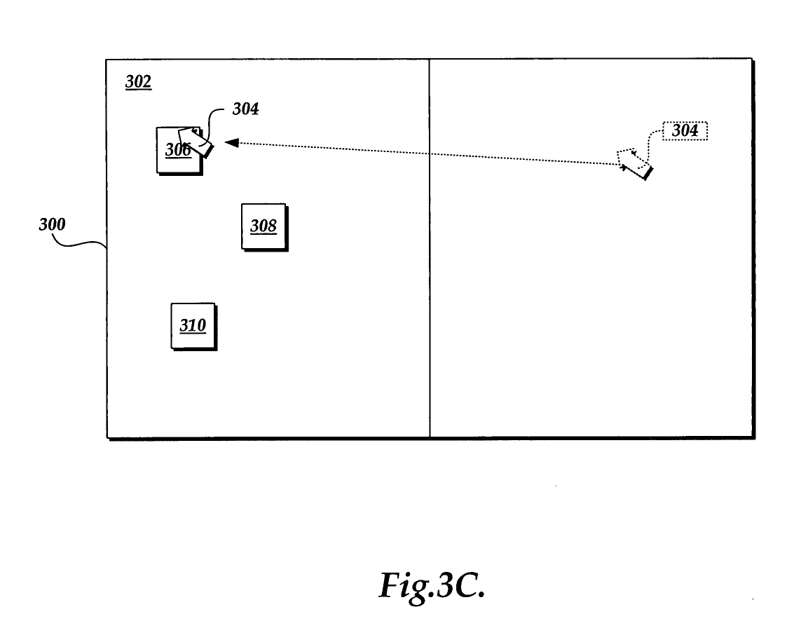

FIG. 3A is a block diagram of screen display 300 having a desktop 302 that can display various display objects. The desktop 302 includes a cursor 304 and multiple display objects 306, 308, and 310. With reference now to FIG. 3B, a projected movement vector 312 has been calculated for the cursor 304, although it would not typically be visible to the user. Although the movement vector has been illustrated as a straight line, one skilled in the relevant art will appreciate that multi-dimensional movement vectors may be calculated. For example, a movement vector may be represented as a two-dimensional shape, such as a rectangle, to identity any display objects that would intersect with the two-dimensional movement vector.

Returning to FIG. 2, at block 204, the computer system automatically moves the cursor 304 to the selected target display object 306. In an illustrative embodiment, the computer system moves the cursor 304 so that it graphically overlaps the selected target display object 306. In an alternative embodiment, the computer system moves the cursor 304 so that it is proximate to the target display object 306. FIG. 3C illustrates the movement of the cursor 304 to the target display object 306. Returning to FIG. 2, at block 206, the sub-routine 200 returns.

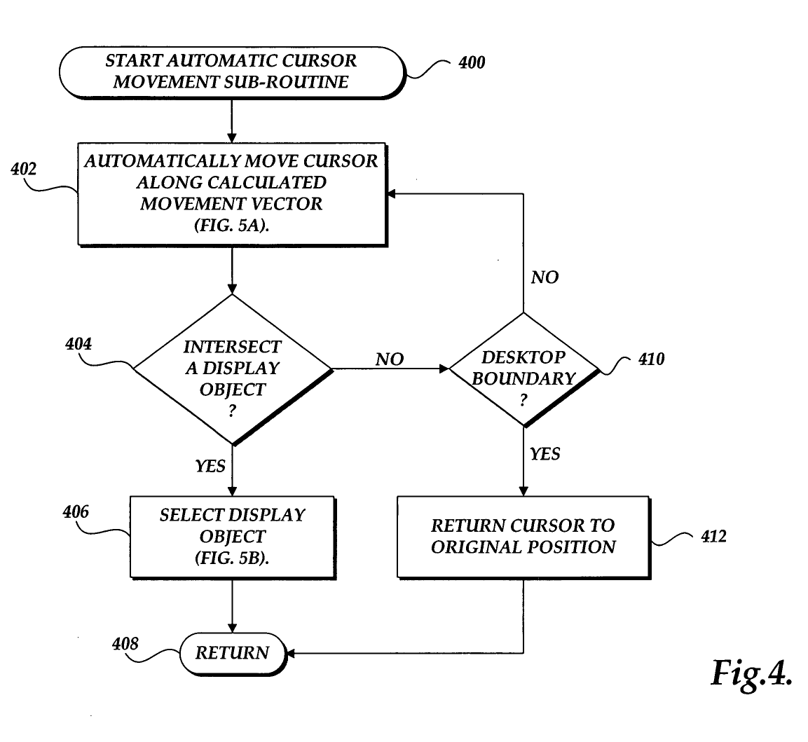

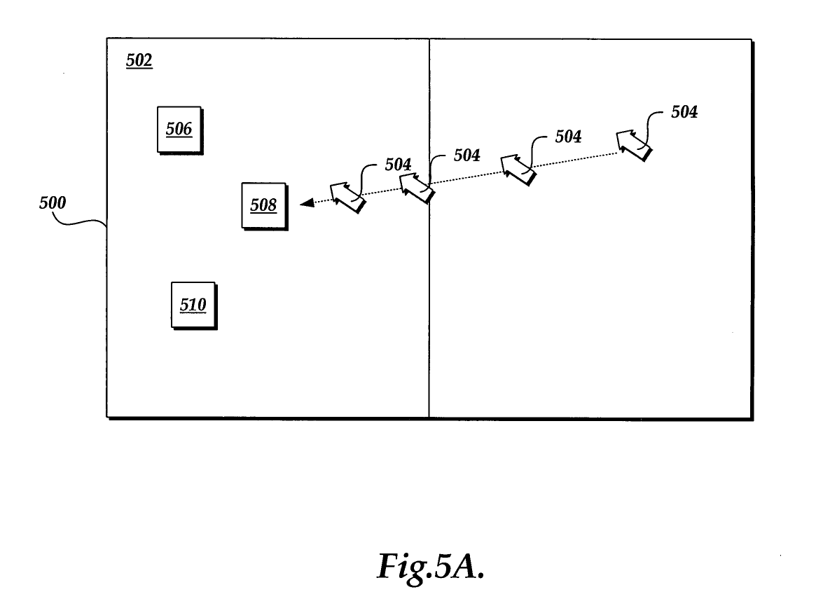

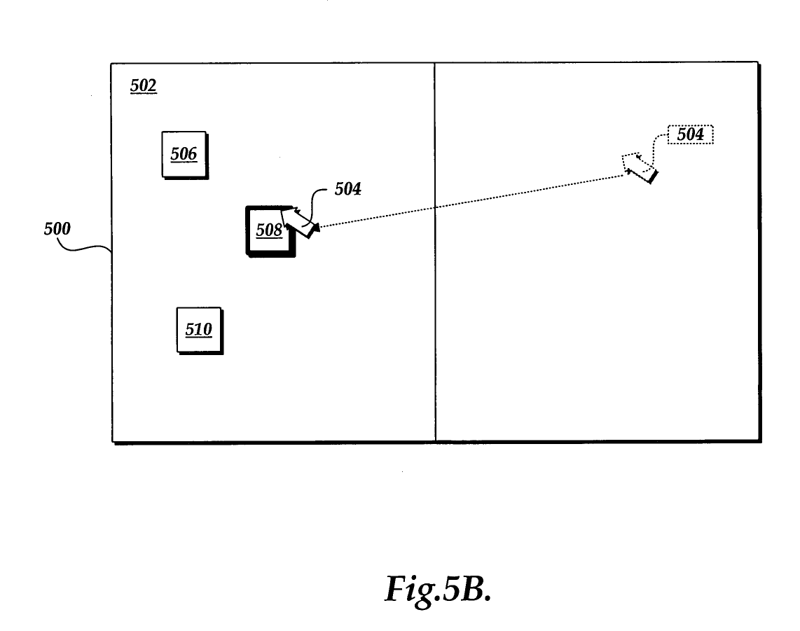

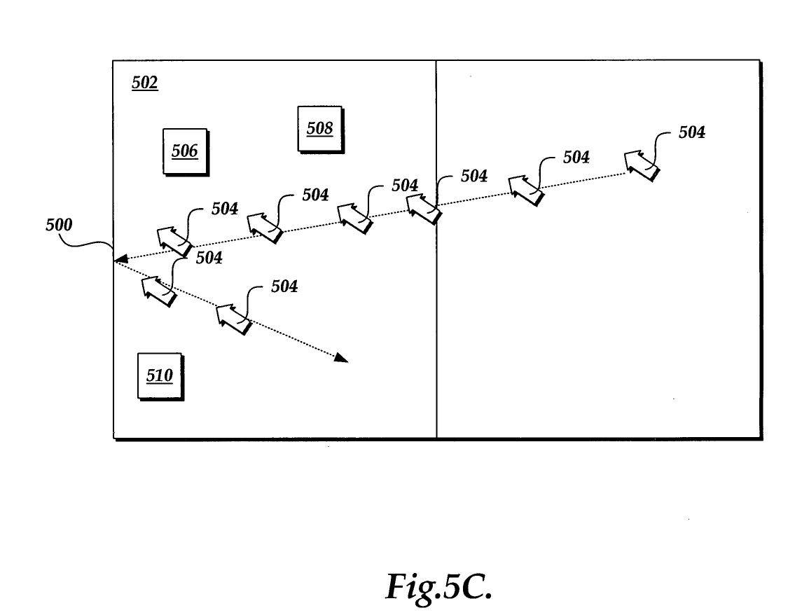

With reference now to FIG. 4, a sub-routine 400 for automatically moving a cursor along a calculated movement vector and corresponding to block 106 (FIG. 1) will be described. At block 402, the computing system begins to move the cursor according to the direction/movement vector. In an illustrative embodiment, the movement of the cursor will be represented on the desktop in a manner similar to simulating movement according to user input. Alternatively, the computer system may change the shape/image used to represent the cursor display object, such as substituting an image of a missile to represent travel, during the movement of the cursor. FIG. 5A is a block diagram of screen display 500 having a desktop 502 that can display various display objects. The desktop 502 includes a cursor 504 and multiple display objects 506, 508, and 510. As illustrated in FIG. 5A, the cursor 504 will be redisplayed along a projected movement vector.

Returning to FIG. 4, at decision block 404, a test is conducted to determine whether the current position of the cursor 504 intersects with any display objects. If the current cursor position intersects or is within a threshold distance, at block 406, the computer system selects the display object and the cursor movement is terminated. FIG. 5B illustrates the selection of a display object 508 based upon travel of the cursor 504 along the movement vector. At block 408, the sub-routine 400 returns.

Alternatively, if the current cursor position does not intersect or is within a threshold distance of display object, at decision block 410, a test is conducted to determine whether the cursor 504 has reached the boundaries of the desktop 502. If so, the computer system may return the cursor 504 to its original starting position at block 412 and the sub-routine 400 returns at block 408. Alternatively, the computer system may allow the cursor 504 to remain at the boundary or cause the cursor to “bounce” and assume travel in another direction. FIG. 5C illustrates the alternate embodiment in which the cursor movement vector changes upon reaching a desktop 502 boundary. If no boundary has been reached, the sub-routine 400 returns to block 402 to continue moving along the movement vector.

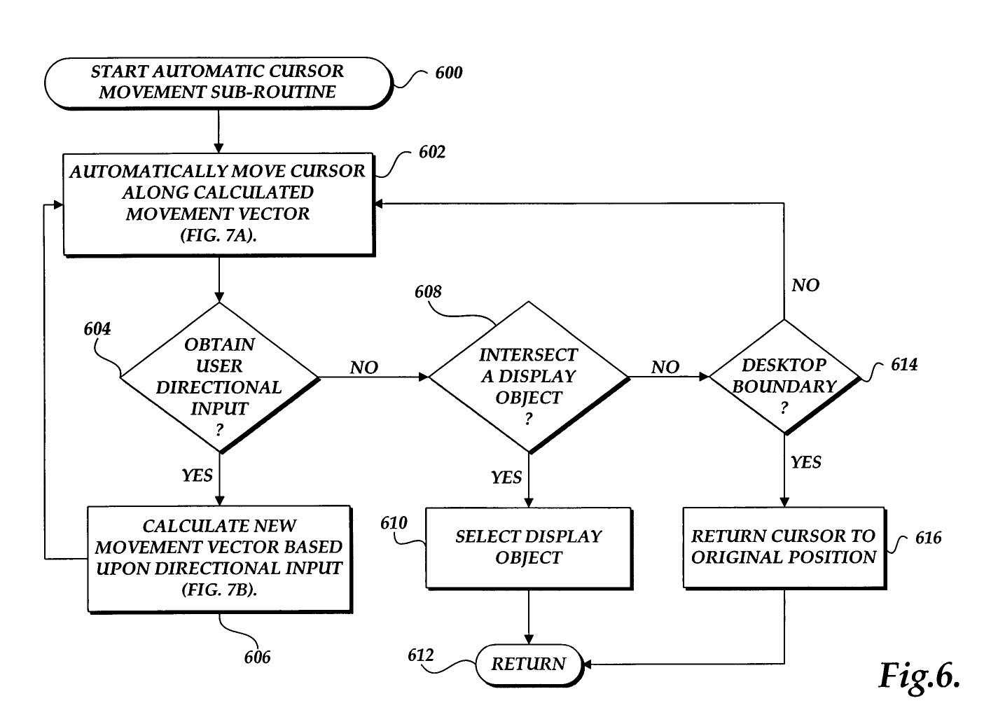

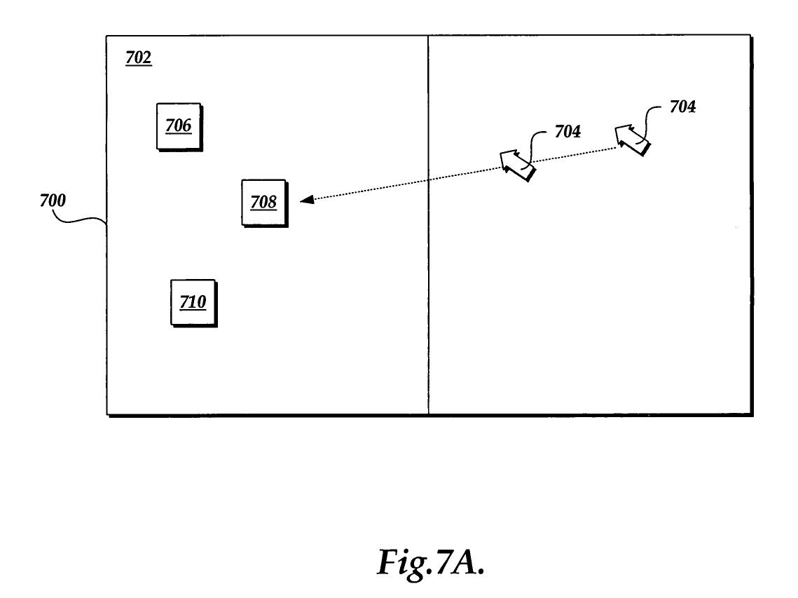

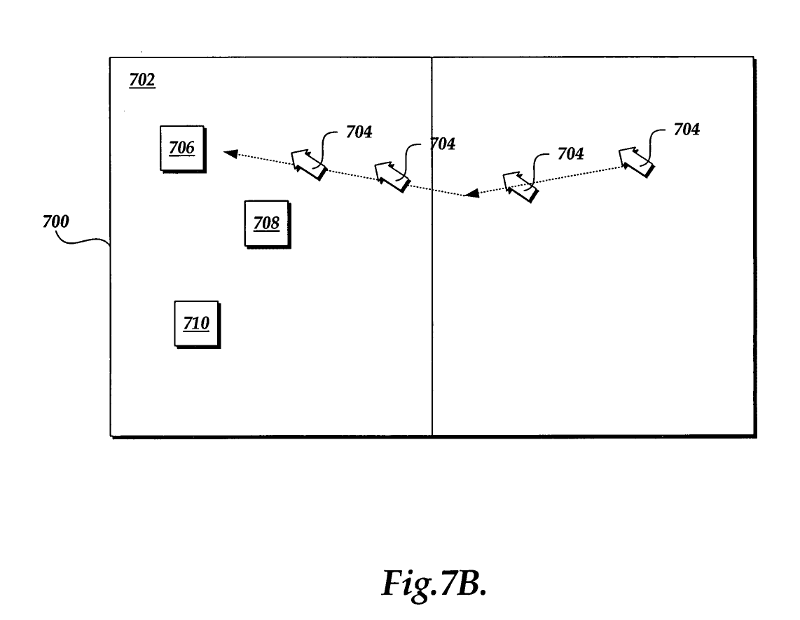

With reference now to FIG. 6, a sub-routine 600 for automatically moving a cursor along a calculated movement vector, incorporating a user-specified directional input, and corresponding to block 106 (FIG. 1) will be described. At block 602, the computing system begins to move the cursor according to the direction/movement vector. In an illustrative embodiment, the movement of the cursor will be represented on the desktop in a manner similar to simulating movement according to user input. FIG. 7A is a block diagram of screen display 700 having a desktop 702 that can display various display objects. The desktop 702 includes a cursor 704 and multiple display objects 706, 708, and 710. As illustrated in FIG. 7A, the cursor 704 will be redisplayed along a projected movement vector.

Returning to FIG. 6, at decision block 604, a test is conducted to determine whether any user directional input has been received. In an illustrative embodiment, the user can utilize input devices, such as the mouse, the arrow keys on a keyboard, joysticks, etc. to input directional changes for the movement of the cursor 704. If directional input has been received, at block 606, the computer system calculates a new movement vector based upon the directional input. For example, a single click on the arrow key of a keyboard would influence the movement vector in the direction of the arrow key that is pressed. The sub-routine 600 returns to block 602. FIG. 7B illustrates the modification of the travel of the cursor 704 based on user input.

Returning to FIG. 6, at decision block 606, a test is conducted to determine whether the current position of the cursor 704 intersects with any display objects. If the current cursor position intersects or is within a threshold distance, at block 608, the computer system selects the display object and the cursor movement is terminated. At block 610, the sub-routine 600 returns. Alternatively, if the current cursor position does not intersect or is within a threshold distance of display object, at decision block 612, a test is conducted to determine whether the cursor 704 has reached the boundaries of the desktop 702. If so, the computer system may return the cursor 704 to its original starting position at block 614 and the sub-routine 600 returns. Alternatively, the computer system may allow the cursor 704 to remain at the boundary or cause the cursor to “bounce” and assume travel in another direction. If no boundary has been reached, the sub-routine 600 returns to block 602 to continue moving or wait for additional user directional input.

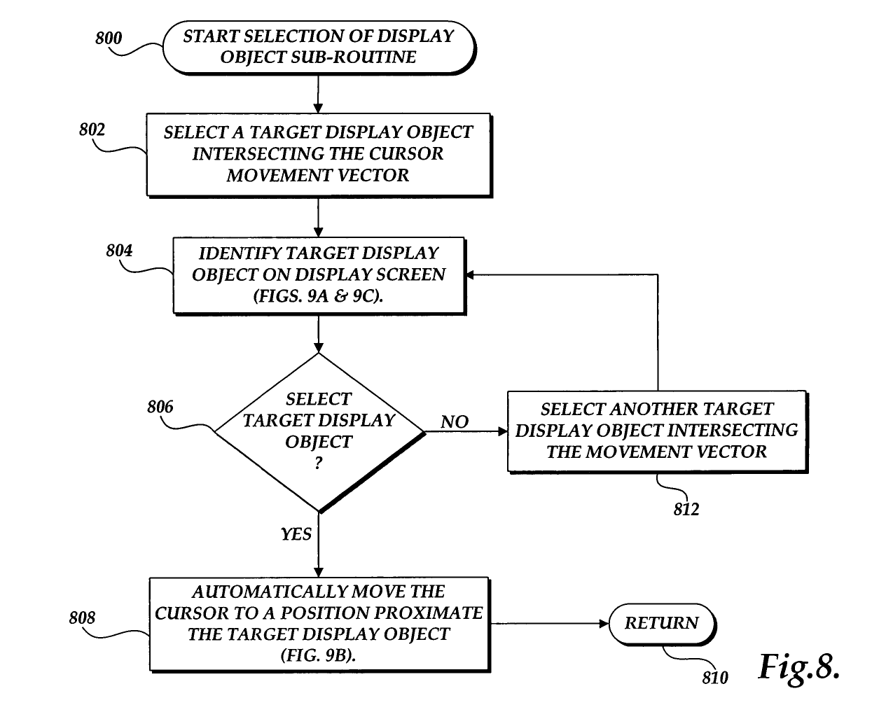

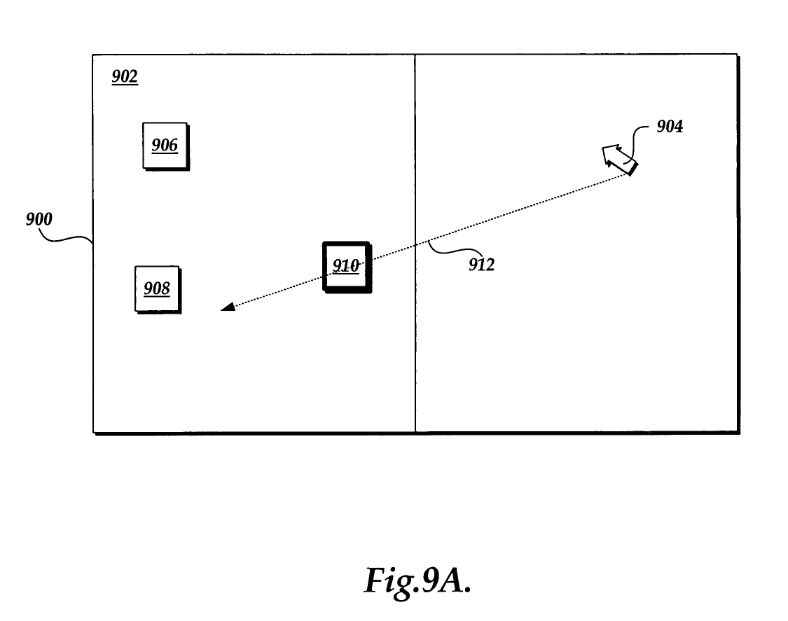

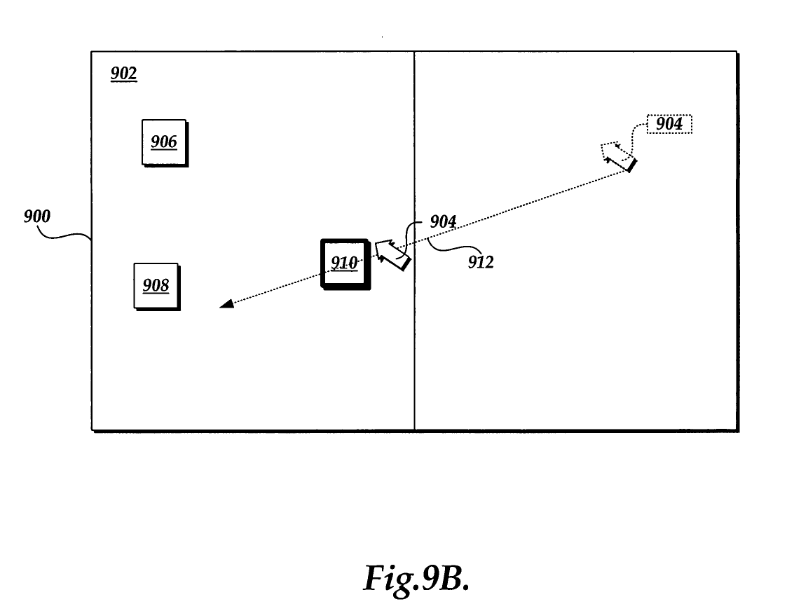

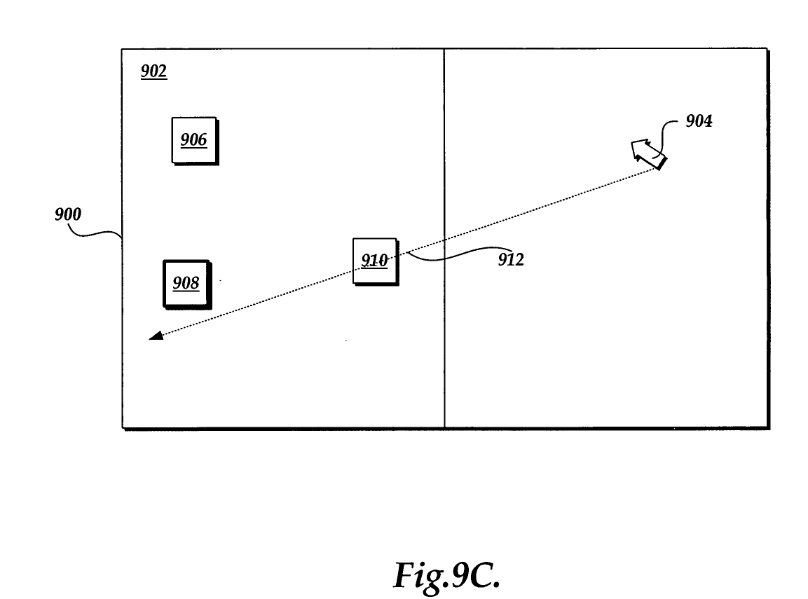

With reference now to FIG. 8, a sub-routine 800 for automatically selecting display objects along a movement vector of a cursor and corresponding to block 106 (FIG. 1) will be described. At block 802, the computing system selects a target display object based on the calculated direction/movement vector of the cursor. In an illustrative embodiment of the present invention, the current movement vector can be projected along the desktop area of the display screen. Any display objects intersected by the project movement vector may be considered potential target display objects. Additionally, additional display objects within a threshold distance, such as measured in a pixels, may be also be considered potential target display objects. If multiple display objects may be potential target display objects, the computer system may utilize selection criteria to select a specific display object. For example, the computer system may select display objects that intersect the movement vector over display objects that are within the threshold distance. Similarly, the computer system may select display objects that are closer to the current position of the cursor over display objects that are further away. If no display objects intersect with the projected movement vector or are outside of a provide range, no display objects may be selected. Alternatively, the computer system may select a display object most close to the movement vector. At block 804, the target display object is highlighted on the desktop. FIG. 9A is a block diagram of screen display 900 having a desktop 902 that can display various display objects. The desktop 902 includes a cursor 904 and multiple display objects 906, 908, and 910. The cursor 904 has a movement vector 912 (based upon a detected user manipulation) that is set to intersect with display object 910. As illustrated in FIG. 9A, the display object 910 has been highlighted as being the target display object.

At decision block 806, a test is conducted to determine whether the user wants to select the highlighted display object. In an illustrative embodiment, the user many manipulate an input device, such as a keyboard or mouse, to provide an indication that the target object is desired. Additionally, the user can manipulate another input device control to indicate that he/she wishes to identify another target object.

If the user accepts or selects the identified target object, at block 808, the computer system automatically moves the cursor 904 to the selected target display object 910. The sub-routine 800 returns at block 810. As described above, the computer system can move the cursor 904 so that it graphically overlaps the selected target display object 910. FIG. 9B illustrates the movement of the cursor 904 to the selected target display object 910. If at decision block 806, the user does not accept the target display object or otherwise initiates a request for a new target display object, at block 812, a new target display object is selected and the routine 800 returns to block 804. FIG. 9C illustrates the selection of a second target display object 908.

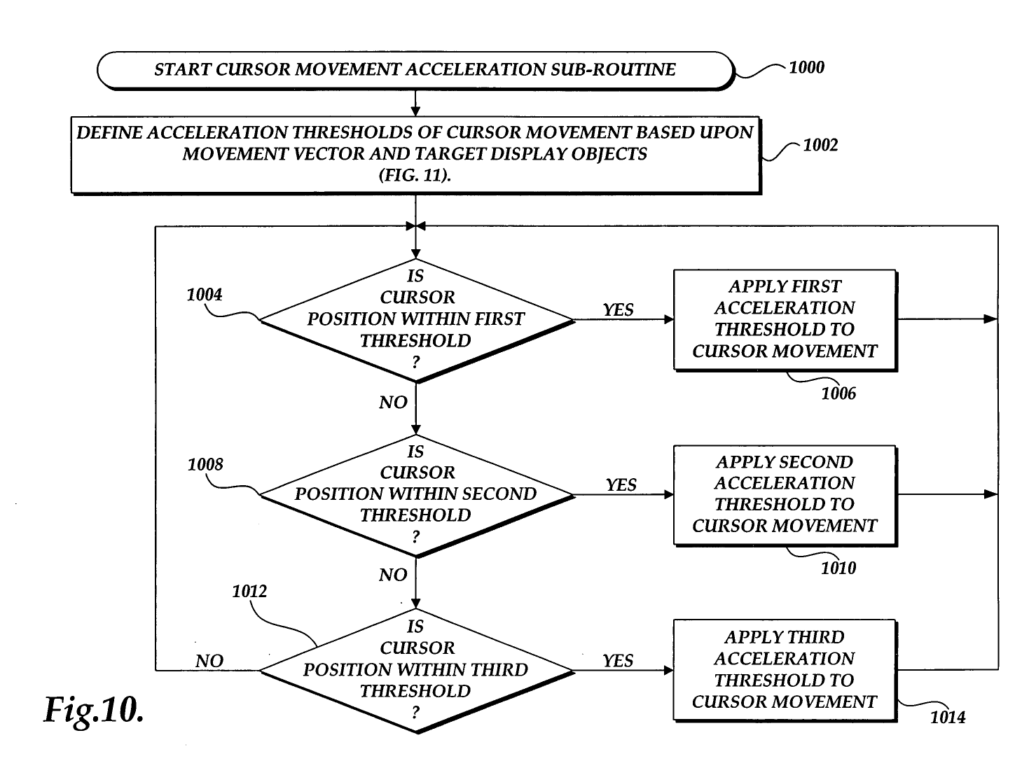

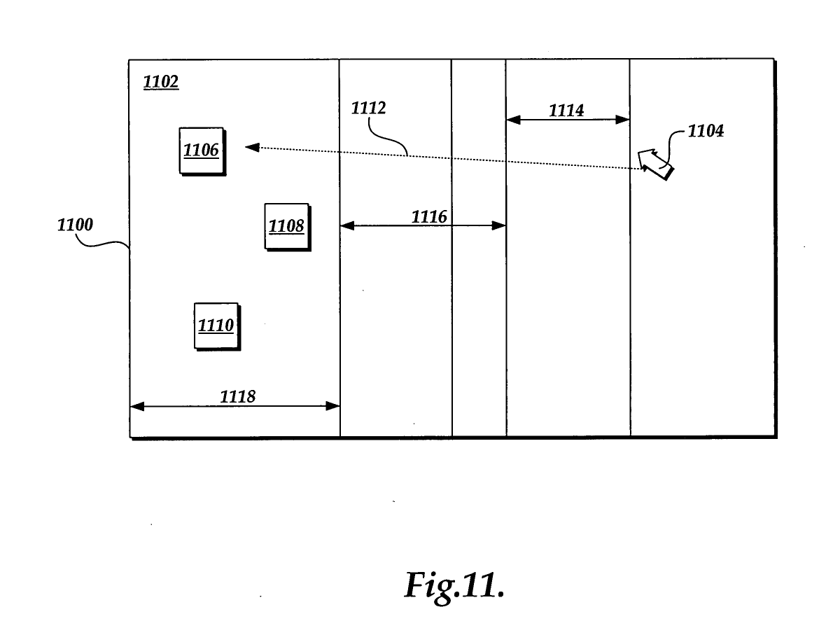

With reference now to FIG. 10, a sub-routine 1000 for associating various acceleration vectors for cursor movement based upon the current location of the cursor and the current location of a target display object and corresponding to block 106 (FIG. 1) will be described. At block 1002, the computer system defines various acceleration thresholds. In an illustrative embodiment, the computer system defines a first threshold corresponding to a current location of a cursor that will have a relatively slow cursor movement. The computer system will define a second threshold that will have relatively faster cursor movement to facilitate faster movement through a portion of the desktop. The computer system will then define a third threshold corresponding to a target data object that will have relatively slow cursor movement. FIG. 11 is a block diagram of screen display 1100 having a desktop 1102 that can display various display objects. The desktop 1102 includes a cursor 1104 and multiple display objects 1106, 1108, and 1110. The screen display 1100 also includes a cursor movement vector 1112 (based on a detected user manipulation) and three distinct acceleration zones 1114, 1116, and 1118 as described above.

Returning to FIG. 10, at decision block 1004, a test is conducted to determine whether the current cursor position is within the first acceleration threshold. If so, at block 1006, the computer system applies a first acceleration to any cursor 1104 movement. If the current cursor position is not within the first acceleration threshold, at decision block 1008, a test is conducted to determine whether the current cursor position is within the second acceleration threshold. If so, at block 1010, the computer system applies a second acceleration to any cursor 1104 movement. If the current cursor position is not within the first or second acceleration threshold, at decision block 1012, a test is conducted to determine whether the current cursor position is within the third acceleration threshold. If so, at block 1014, the computer system applies a third acceleration to any cursor 1104 movement. The sub-routine 1000 will repeat during movement of the cursor 1104.

While illustrative embodiments of the invention have been illustrated and described, it will be appreciated that various changes can be made therein without departing from the spirit and scope of the invention.

The embodiments of the invention in which an exclusive property or privilege is claimed are defined as follows:

1. A method for facilitating a location of a cursor in a screen display, the method comprising:
obtaining a user manipulation of a cursor displayed on the screen display;
determining a direction for the user manipulation of the cursor; and
generating at least one visual cue relating to the detected user manipulation.

2. The method as recited in claim 1, wherein the user manipulation of the cursor corresponds to the manipulation of a pointing device.

3. The method as recited in claim 1, wherein the screen display includes one or more display objects and wherein generating at least one visual cue relating to the detected user manipulation includes:
identifying a target display object on the screen display; and
automatically moving the cursor to the target display object.

4. The method as recited in claim 3, wherein identifying a target display object on the screen display includes identifying a display object that will intersect with a vector corresponding to the direction of the user manipulation of the cursor.

5. The method as recited in claim 3, wherein generating at least one visual cue relating to the detected user manipulation includes:
calculating a vector corresponding to the direction of the user manipulation of the cursor; and
automatically moving the cursor along the calculated vector.

6. The method as recited in claim 5, wherein the display screen includes one or more display objects, the method further comprising selecting a display object intersected by the movement of the cursor along the calculated vector.

7. The method as recited in claim 5 further comprising:
obtaining a directional input corresponding to the calculated vector; and
calculating a second vector corresponding to the directional input and the vector corresponding to the direction of the user manipulation of the cursor; and
automatically moving the cursor along the second calculated vector.

8. The method as recited in claim 1, wherein the display screen includes one or more display objects and wherein generating at least one visual cue relating to the detected user manipulation includes:
calculating a vector corresponding to the direction of the user manipulation of the cursor; and
selecting at least one display object that most closely intersects the calculated vector; and
identifying the at least one display object that most closely intersecting the calculated vector.

9. The method as recited in claim 8 further comprising:
obtaining a user selection of the identified at least one display object; and
automatically moving the cursor to the target display object.

10. The method as recited in claim 8 further comprising:
selecting a second display object that most closely intersects the calculated vector; and
identifying the second display object.

11. The method as recited in claim 8, wherein selecting at least one display object that most closely intersects the calculated vector includes selecting a display object based upon a distance most close to the calculated vector and a distance most close to a current position of the cursor on the screen display.

12. The method as recited in claim 1, wherein generating at least one visual cue relating to the detected user manipulation includes:
associating an acceleration rate for the cursor based upon a current position on the display screen; and
accelerating the cursor in accordance with the associated acceleration rate.

13. The method as recited in claim 12, wherein the acceleration rate is based upon an estimated distance from a current cursor position to a target display object.

14. In a desktop area corresponding to two or more display screens having a plurality of display objects displayed on the desktop area, a method for facilitating a location of a cursor in the desktop area, the method comprising:
obtaining user manipulation of a cursor displayed on the screen display;
calculating a movement vector corresponding to the user manipulation of the cursor; and
modifying the display of the cursor based upon the movement vector.

15. The method as recited in claim 14, wherein modifying the display of the cursor based upon the movement vector includes:
identifying a target display object on the screen display intersecting the movement vector; and
automatically moving the cursor to the target display object.

16. The method as recited in claim 14, wherein modifying the display of the cursor based upon the movement vector includes automatically moving the cursor along the calculated vector on the display screen.

17. The method as recited in claim 16 further comprising:
obtaining a directional input corresponding to the movement vector; and
calculating a second movement vector corresponding to the directional input and the movement vector corresponding to the direction of the user manipulation of the cursor; and
automatically moving the cursor along the second calculated movement vector.

18. The method as recited in claim 14, wherein modifying the display of the cursor based upon the movement vector includes:
selecting at least one display object that most closely intersects the movement vector;
identifying the at least one display object that most closely intersecting the movement vector;
obtaining a user selection of the identified at least one display object;
automatically moving the cursor to the target display object

19. The method as recited in claim 14, wherein modifying the display of the cursor based upon the movement vector includes:
associating an acceleration rate for the cursor based upon a current position on the display screen; and
accelerating the cursor in accordance with the associated acceleration rate . . .

20. A computer system for facilitating the location of a cursor on a screen display, the computer system comprising:
a movement direction component for determination a movement vector based upon a current position of a cursor and a user manipulation of the cursor on the display screen; and
means for modifying a user interaction with the cursor based upon the movement vector.
